(19) United States
(12) Patent Application Publication
(10) Pub. No.: US 2003/0041783 A1
(43) Pub. Date: Mar. 6, 2003

(54) Cementitious composition containing glass powder as a pozzolan

(75) Inventor: Tarig M. Monawar, New York, NY (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Zstone Technologies, LLC

(21) Appl. No.: 10/272,132

(22) Filed: Oct. 15, 2002

Related U.S. Application Data
(63) Continuation of application No. PCT/US01/11862, filed on Apr. 12, 2001.

(51) Int. Cl. C04B 14/22

(52) U.S. Cl. 106/716; 106/718

(57) ABSTRACT

Cementitious compositions, which may make use of waste glass, comprise glass material, calcined kaolin and a cement. Also provided are cementitious binders and solidifiable cementitious compositions (such as mortars and concretes) incorporating the cementitious compositions. The cementitious composition is mixed with water to form the cementitious binder, and aggregate is added to the cementitious binder to form the solidifiable cementitious compositions. Solidifiable cementitious compositions formed from the cementitious compositions have comparable or superior short-term strength and superior long-term strength to solidifiable cementitious compositions formed from conventional cementitious compositions.

### CROSS-REFERENCE TO RELATED APPLICATION

This is a continuation of International Application No. PCT/US01/11862, filed Apr. 12, 2001, which was published in the English language on Oct. 25, 2001, under International Publication No. WO 01/79131 A1.

### BACKGROUND OF THE INVENTION

The ecologically sound disposal of post-consumer municipal waste has become a matter of increasing concern in recent years with the decreasing availability of landfill space. Considering that post-consumer waste glass accounts for a substantial percentage of this waste, there is a continuing effort to recover and use waste glass that would otherwise end-up in landfills.

Currently, most post-consumer recovered waste glass is used by glass manufacturers in the production of new glass articles such as bottles. But, only a limited amount of the available supply of waste glass can be used towards the production of new glass articles because manufacturers can only use waste glass that has been pre-sorted by color and type. This excludes waste glass that is of mixed colors (“mixed color waste glass”), which is costly to sort by color and type. Alternative uses for waste glass that cannot be used in the production of new glass articles have been developed, such as the use of waste glass in the production of fiberglass, in the process of sand-blasting, and in the production of abrasive materials. Nonetheless, this still leaves large amounts of potentially recyclable mixed color waste glass that must be disposed of in landfills, exacerbating the shortage of landfill space, particularly in the vicinity of large cities. Thus, there has been a continuing effort to find additional uses for mixed color waste glass.

One use for mixed color waste glass that has been investigated is as an aggregate in building and construction materials, such as in asphalt for street paving and in concrete to make glass concrete. In these cases the glass is crushed into smaller pieces and added to the binder materials as a filler or extender; the waste glass in these cases has no binding properties of its own. While these applications do provide additional uses for mixed color waste glass, it may not be sufficiently cost effective to be commercially practicable in the many geographical areas where conventional aggregates are relatively inexpensive.

A more constructive use for the waste glass is as a pozzolan. A pozzolan is a cementitious material added to a cement composition to prevent deterioration and increase the long-term strength of concrete and mortar products made from the cement composition. Also, because pozzolans are typically less expensive than conventional cements, such as Portland cement, when a portion of the conventional cement is replaced with a pozzolan, the overall cost of the cement composition is reduced.

While the use of waste materials such as slag and fly ash as pozzolans is widespread, if not common, waste glass has been little used as a pozzolan in the construction industry because products based on cementitious compositions that contain waste glass as a pozzolan are typically inferior to products formed from cementitious compositions containing only conventional cements, such as Portland cement. In particular, it has been observed that cement formulations that include waste glass powder as a pozzolan produce low early strength properties because of the low pozzolanic reactivity of waste glass powder, and consequently such cement formulations can be used only in construction applications where low early strength properties are not detrimental, such as in stabilizing mine backfills. Accordingly, a cement that contains a glass powder pozzolan and has early strength properties that are comparable to conventional cement compositions would have greater applicability in the construction industry and increase the use of waste glass as a pozzolan, while at the same time being more cost effective than conventional cement formulations.

Given the foregoing, there is a continuing need for a cement composition that incorporates waste glass as a pozzolan, so that products made from this cement composition have early strength properties comparable to products made from conventional cement compositions containing Portland cement and long-term strength properties that are comparable or superior to such products.

### BRIEF SUMMARY OF THE INVENTION

The present invention relates to a cementitious composition that comprises cement, glass powder and calcined kaolin.

The present invention also includes a cementitious binder composition comprising a mixture of water and the cementitious composition.

The present invention also includes a solidifiable cementitious composition, such as a mortar or concrete, comprising the cementitious binder and an aggregate.

### DETAILED DESCRIPTION OF THE INVENTION

By “cement” is meant an inorganic compound that when combined with water sets to form a hard product as a result of the hydration of the inorganic compound. A “cementitious composition” is a material that has binding properties when mixed with water and includes both conventional cements, like Portland cement, and also glass powder as a pozzolan as well as other, optional components, such as cement additives. By “early strength properties” is meant the strength properties and performance that a material exhibits seven days after completion of molding.

The ingredients of the cementitious composition prepared according to the present invention will now be discussed in greater detail. Subsequently, products that can be made from the cementitious composition such as a cementitious binder and solidifiable cementitious compositions such as concrete and mortar materials, will be discussed.

All parts, percentages and ratios used herein are expressed by weight unless otherwise specified. All documents cited are incorporated herein by reference.

The cementitious composition of the present invention contain glass powder as a pozzolan and calcined kaolin, as well as conventional cement such as Portland cement or gypsum. This glass powder is often less expensive than conventional cement and by replacing a portion of the conventional cement with the powder, the cost of the overall cementitious composition can be reduced. Moreover, by functioning as a pozzolan, the glass powder can also perform the extremely important function of consuming excess calcium hydroxide in the cementitious composition. Excess calcium hydroxide, which is formed as a by-product of the reaction between hydraulic cements and water, is detrimental because over a period of months or even years the calcium hydroxide can react with chemicals in the environment to weaken solidified concrete or mortar products made from the cementitious composition.

Glass powder suitable for use in the present invention is formed from glass material including soda-lime glass, borosilicate glass, and lead glass. Soda-lime glass, which is a mixture of silica, Na₂O, and CaO is the most common form of glass used today and the most common form of post-consumer waste glass. Borosilicate glass, which is a mixture of silica and B₂O₃, is less common but still widely used in materials because of its resistance to chemical and temperature degradation. The most common form of borosilicate glass is PYREX glass. Lead glass, a mixture of silica, Na₂O, and PbO, may also be used, although it is less common than the previous two types in post-consumer waste glass. These glass materials may include optional modifiers and additives such as metal oxides and gallium or tin, which contribute to glass vitrification. The glass materials may also include various chemical impurities such as ceramic and metal wastes. Metal wastes include quantities of iron and lead, which have not been added to the glass material as chemical modifiers. The glass material used herein may be of any color and must itself be freed of contaminants such as paper, foils, glues, foodstuffs and the like by a thorough cleaning of the glass material. Suitable processes for removing these contaminants from glass material are well-known to those of ordinary skill in the art.

Additionally, it is preferred that the glass material added to the cementitious compositions does not contain high quantities of certain modifiers and intermediates. Notably, it is preferred that the glass material contains less than 10 wt % of K₂O, and less than 2 wt % of P₂O₅. It is also preferred that the present cementitious compositions be free of quaternary ammonium silicates.

Specifically excluded from the scope of the present invention are the cementitious glass materials disclosed in U.S. Pat. Nos. 4,440,576, 3,720,527, and 3,743,525. Each of these patents discloses a cementitious material referred to as a “glass”, but in fact the material disclosed in each of these patents is very different from the common glass material formed into a powder and used in the present invention.

In each of these patents, a unique species of SiO₂-containing material having cementitious properties is produced as a result of the following special formulation and processing steps. First, the SiO₂-containing materials are specially formulated to incorporate certain special metal oxides to enhance their binding properties, e.g. K₂O and P₂O₅, in concentrations far higher than they would be found in conventional glass materials. This composition is then mixed together to form a ceramic mix, heated and melted to a temperature of between 1500° C. and 1700° C., and then rapidly cooled to form a supercooled glass structure. Thus, the resulting material is a specialized structural material that is a “glass” only in a specific physical and chemical sense, i.e. it is an amorphous solid lacking long-range order and containing SiO₂. It is not a “glass” as the term is most typically used to generically refer to common structural materials such as silicate glass, soda-lime glass, borosilicate glass, and lead glass as described above. Thus, the “glass” in U.S. Pat. Nos. 4,440,576, 3,720,527, and 3,743,525 is a specially formulated and processed amorphous solid that has hydraulic and cementitious properties, while in the present invention the glass material is common commercial glass material.

The source of the glass material is not critical to the present invention, and may even include freshly manufactured glass, but it is preferred that the glass material be post-consumer waste glass, as this may increase the cost-effectiveness and economic viability of the presently disclosed materials as well as provide an alternative to dumping the waste glass in landfills. By “post-consumer waste glass” is meant glass that is no longer necessary to perform the function for which it was formulated and formed. Glass containers that have been emptied of a consumable product, as well as glass containers or other glass articles that are broken or no longer usable for some other reason are all examples of post-consumer waste glass.

After the glass material is obtained and thoroughly cleaned, it is crushed, ground, pulverized or otherwise processed into glass powder. Various types of crushing and grinding equipment and other like equipment can be used to produce particulate glass powders. Examples of such equipment include the ball-medium type, medium agitating type, fluid-energy type, impact-pulverizing type, and other like machines. It is preferred that substantially all of the glass particles used in the present invention will pass through a No. 70 mesh sieve (as designated in the U.S. Sieve Series), and it is more preferred that about 80% to about 100% of the glass particles, by weight, will pass through a No. 100 mesh sieve. Particle size can be conveniently measured by using a series of vibrating screens stacked upon top of each other. This method is discussed in greater detail in ASTM Protocol E11-95 (“Standard Specification for Wire Cloth and Sieves for Testing Purposes”) and Perry's Chemical Engineering Handbook, pages 21-13-21-17, Table 21-6; 6th Ed., McGraw-Hill, Inc., New York, N.Y. (1984). This small particle size of the glass powder is preferred because it increases the surface area on which the reaction between the cement, calcined kaolin, and glass powder occur, thus increasing the rate of reaction.

It is an essential feature that the cementitious compositions of the present invention also include calcined kaolin

It is preferred that the glass powder and the calcined kaolin be included in the cementitious composition of the present invention so that the weight ratio of glass powder to calcined kaolin is about 20:1 to about 1:2, more preferably about 6:1 to about 1.5:1. It is preferred that the calcined kaolin be present as particles with a particle size in the range of about 0.1 μm to about 50 μm. Again, fine particle sizes are preferred as they increase the surface area on which reactions between the cement, calcined kaolin and glass powder can occur.

Kaolin is a fine, white, clay mineral, composed mostly of hydrated aluminum disilicate, commonly known as kaolinite, Al₂Si₂O₅(OH)₄ nH₂O (wherein nH₂O is interlayer water and n is greater than 0). Kaolinite consists of silicate sheets that are ionically bonded to sheets of AlO(OH)₂. As used in the present invention, “kaolin” is meant to refer to kaolin, kaolinite and other kaolin group minerals. It should additionally be noted that kaolin is often specifically designated by putting the name of the place of origin before the “kaolin”, such as Korea kaolin, Georgia kaolin, New Zealand kaolin, etc.

Specifically, calcined kaolin is a thermally activated, amorphous form of kaolin. Calcined kaolin is prepared by heat treating kaolin at a temperature in the range of about 600° C. to 900° C., preferably around 700° C. By heating the kaolin to this temperature the kaolin loses water by dehydoxylization, resulting in a calcined kaolin that is activated, amorphous and disordered (in both two and three dimensions), as well as highly pozzolanic.

The time period of the aforementioned heat treatment varies depending on the exact temperature of the heat treatment: the higher the treating temperature, the shorter the heat treating time. Typically the time period may be as short as several minutes to as long as about 5 to 6 hours. The atmosphere of this heat treatment is preferably air or inert gas.

Along with the calcined kaolin and the glass powder, the cementitious compositions also include cement. The most preferred cements are Portland cement, high alumina cement, and gypsum or a mixture of these cements.

The present cementitious compositions may also include optional cement additives. A particularly suitable additive is a superplasticizer (also known as water-reducer). Superplasticizer compounds reduce the amount of water necessary to mix with the cement composition to produce a cementitious binder of acceptable workability and thus increase the strength of concrete products formed from such cement. Conventional superplasticizers include lignosulfonate derivatives, condensed naphthalene sulfonates, or carbohydrate esters. POZZOLITH 440-N™ produced by Master Builders Technologies and DARACEM 100™ produced by the W.R. Grace & Co. are suitable commercially available examples of superplasticizers.

Other suitable additives include retardants, which delay setting time and are particularly useful for forming operations in high-temperature environments, and accelerants, which accelerate setting times and are useful for forming in low-temperature environments. Air entrainers, which improve workability, may also be used.

The cementitious compositions of the present invention preferably include about 60% to about 93%, more preferably about 75% to about 85%, of a particulate inorganic cement; about 5% to about 38%, more preferably about 12% to about 19% of glass powder as a pozzolan; and about 2% to about 12%, more preferably about 3% to about 8% of calcined kaolin.

In actual use, the present cementitious compositions are mixed with water to form a cementitious binder composition, which can be solidified or used as the basis for a solidifiable cementitious composition. The weight ratio of water to cement in the binder is from 0.15 to about 0.8:1, preferably about 0.3 to about 0.5:1.

These cementitious binder compositions may be mixed with mineral aggregate particles to from a solidifiable cementitious composition, such as a concrete or mortar. This binder forms a matrix in concrete or mortar products to hold together the aggregate particles. Aggregate particles are inert solid bodies that form most of the volume of a concrete article. When mixed with aggregate, the cementitious binder composition forms a binder matrix that holds the aggregate together.

Such solidifiable cementitious compositions are typically classified as concretes or mortars, depending on the particle size of the aggregate. Concretes usually contain both coarse and fine aggregates, whereas mortars contain fine aggregate but no coarse aggregate. The proportions of coarse and fine aggregate used in a concrete depend on the required properties and intended use, which are well-known to those of ordinary skill in the art.

Aggregates for use in concrete are described in ASTM C33-90 “Standard Specification for Concrete Aggregates”. In general, coarse aggregates, which include gravel and crushed limestone, fall within the range of 2 inches to ⅔ inch mesh; and fine aggregates, such as sand, fall in the range of No. 4 mesh to No. 200 mesh of ASTM C-11.

In addition, fibers or other strength-enhancing additives commonly-known to those skilled in the art can be added to the present solidifiable cementitious compositions to enhance the tensile strength, impact resistance or beneficially affect other important properties. Particularly useful are ferro-cement composites in which shapes of reinforcing metal bars or rods are embedded in the solidifiable cementitious compositions. As the concrete cures, the reinforcing bars and the concrete bond together. A particularly preferred reinforcing material is a ribbed steel rod coated with an epoxy to prevent corrosion. During usage of this ferro-cement composite, when a tensile force is applied to the concrete it is transferred to the reinforcing bars. In addition or alternatively to using metal reinforcing rods, a metal wire mesh may also be used as the reinforcement material. The use of reinforcing metallic rods and/or meshes may also be used in mortars, as well as in concretes. Suitable fibers include steel or polymeric fibers (e.g., nylon fibers).

The cementitious compositions of the present invention, as well as the cementitious binders and the solidifiable cementitious compositions produced from these cementitious compositions, may be made by using any standard mixing and forming processes commonly-known to those skilled in the art. The manner of combining and mixing ingredients to form the hydraulic cement compositions and the cementitious binders and solidifiable compositions is not restricted to any particular embodiment. These components may be mixed and combined in any order, at a variety of different temperatures and in a variety of different machine and apparatus configurations according to the needs of the user. The present invention also contemplates the use of suitable inter-grinding processes, i.e., grinding of the unmixed combination of the ingredients together into a mixture, so that mixing occurs simultaneously with grinding. An example of this is when the glass material is ground into powder along with the cement clinker.

After the cement and aggregate are mixed to form a solidifiable cementitious composition, such as a concrete or mortar mix, the solidifiable composition is “placed”, meaning it is poured, pressed, or otherwise processed into the shape into which it is to set or “solidify”. The solidifiable cementitious composition may be placed by pouring it into a wooden or steel form so that it hardens into the desired shape. Alternatively, the solidifiable cementitious composition may be placed by hand-troweling it into the desired shape. The solidifiable cementitious composition that has “set” or “hardened” into its desired shape may be referred to as the “solidified solidifiable cementitious composition.”

The process for setting and hardening of the solidifiable cementitious composition into the solidified solidifiable cementitious composition is not restricted to any particular embodiment, and any suitable process known to those of ordinary skill in the art may be used. The preferred process includes applying a protective medium to retain moisture, wet curing, or autoclave curing.

It is preferable that after curing, a solidified and cured solidifiable cementitious composition prepared according to the present invention will have a compressive strength of at least about 53 MPa.

By formulating and processing cementitious compositions as described above, it has been determined that waste glass can be used as a pozzolan and a partial replacement for a portion of the cement in the cementitious composition, so that solidified concrete and mortar products made from such a cementitious composition exhibit early and long-term strength properties comparable to or better than the strength properties of similar products made with conventional cements.

Additionally, cementitious binders made from these cementitious compositions have improved rheology and workability, which makes them easier to mix with an aggregate under field service conditions to form the solidified concrete and mortar products. Thus, the present formulations for cementitious compositions offer many benefits over the conventional cement compositions that are well-known in the art.

Although not wishing to be limited by theory, it is believed that these benefits are the result of including calcined kaolin within the cementitious compositions. In particular, it is known that when a cement is mixed with water, calcium hydroxide (more commonly known as “lime”) is produced as a byproduct of the hardening reaction between the calcium silicates in the cementitious composition and water. In the present invention, it is thought that the calcined kaolin initially reacts with the powdered glass to form active metal alkali compounds that break down the amorphous structure of the glass material, allowing the silica in the glass powder to react with the calcium hydroxide to result in the production of high-strength, cementitious calcium silicate and alumino-silicate materials. Thus, the loss of strength resulting from the replacement of a portion of the Portland cement with glass pozzolan is offset or more than offset by the creation of these cementitious materials.

As the material hardens, the calcined kaolin catalyst also contributes to long-term strength and stability. Particularly when the waste glass powder is made from soda-lime glass, the calcined kaolin provides aluminum ions that combine with the calcium, sodium, aluminum and silica compounds in the glass to form highly stable zeolite compounds, thus enhancing long-term stability.

As the solidifiable cementitious composition (in the form of mortars, concretes, and the like) hardens over time it gains superior strength as well as excellent durability compared to mortar and concretes made with conventional cements. It is suggested that the gain in strength is attributed to the continuous formation of additional stable calcium compounds from the lime released by the cement. Further, it is suggested that the excellent durability is related to the stabilization of the cement lime, which would otherwise react with chemicals in the environment to weaken the solidified concrete or mortar products made from the cementitious composition.

The cementitious compositions of the present invention that incorporate waste glass powder are also shown to have superior workability, when compared to conventional cement compositions, when they are incorporated into a concrete or mortar composition. A concrete or mortar slurry with poor workability may cause air pockets to form upon solidification, thus reducing the strength of products made from the concrete or mortar. This improvement in workability is believed to result from the fact that the glass powder, unlike most conventional pozzolans, is not porous and so does not absorb water. This water remains available during mixing and placing to provide lubrication for added workability.

The invention will now be described in more detail with respect to the following specific, non-limiting examples.

### EXAMPLE I

Tests were carried out to determine the workability of cementitious binder compositions containing different formulations of cement, glass powder and calcined kaolin, as well as to determine the early and long-term strength of solidifiable cementitious compositions (i.e., mortars), which are a combination of the aforementioned cementitious binder compositions and an aggregate.

The chemical compositions of the materials used in the cementitious binder compositions for this test are set forth in Table I, below:

TABLE I

| | Portland | Post-Consumer | |
|---|---|---|---|
| | Cement | Mixed Color Waste | |
| | Type I | Glass | Calcined Kaolin |
| % Al₂O₃ | 4.6 | 1.0 | 41.0 |
| % SiO₂ | 20.9 | 74.0 | 52.1 |
| % TiO₂ | — | — | 0.8 |
| % Fe₂O₃ | 3.1 | — | 4.3 |
| % CaO | 63.5 | 5.4 | 0.1 |
| % MgO | 2.6 | 3.7 | 0.2 |
| % Na₂O | 0.87 | 15.3 | 0.3 |
| % K₂O | — | 0.6 | 0.6 |

Four different solidifiable cementitious compositions were prepared. In the control composition, 100% of the cementitious material was Portland cement. In composition 1, composition 2, and composition 3, 20 wt % of the Portland cement was replaced with glass powder or a mixture of glass powder and calcined kaolin. Table II below indicates the precise formulations for each composition, wherein the amounts are in kilograms of each component per cubic meter of the composition (i.e., wt/vol):

TABLE II

| | Control | | | |
|---|---|---|---|---|
| | Composition | Composition 1 | Composition 2 | Composition 3 |
| Sand Aggregate (kg/m³) | 1566 | 1566 | 1566 | 1566 |
| Water (kg/m³) | 285 | 285 | 285 | 285 |
| Water-to-cementitious | 0.5 | 0.5 | 0.5 | 0.5 |
| composition ratio | | | | |
| Total Cementitious | 570 | 570 | 570 | 570 |
| Composition (kg/m³) | | | | |
| Portland cement type I | 570 | 456 | 456 | 456 |
| (kg/m³) | | | | |
| Glass Powder (kg/m³) | 0.0 | 114 | 91.2 | 79.8 |
| Calcined Kaolin (kg/m³) | 0.0 | 0.0 | 22.8 | 34.2 |
| Wt % of Cementitious | 0.0% | 20% | 16% | 14% |
| Material that is Glass Powder | | | | |
| Wt % of Cementitious | 0.0% | 0% | 4% | 6% |
| Material that is Calcined | | | | |
| Kaolin | | | | |

In preparing the above solidifiable cementitious compositions, the glass material consisted of cleaned, post-consumer mixed color waste glass ground into a powder such that 80% to 100% passed through a No. 325 (U.S.) mesh sieve. The calcined kaolin was also prepared to pass through a No. 325 mesh sieve. A fixed water-cementitious composition weight ratio of 0.5 was used. No water reducer or air entraining agent was added. As directed by ASTM C109/C109 M-99, the materials for each of the compositions were first mixed together with water in a laboratory mixer to obtain a homogeneous cementitious binder composition and then sand aggregate was added to further form a solidifiable cementitious composition, which was in the form of a mortar.

After the completion of mixing, flow table tests were performed on each of the solidifiable compositions, as directed by ASTM-C109/C109M-99, and the average flow recorded. The average flow, an indication of workability (also referred to as “slump”), is the percent increase in the diameter of the mortar after being vibrated compared to the diameter of the same mortar before being disturbed through vibration.

Also as per ASTM C109/C109M-99 the remaining mortar was placed into 2 inch cube molds, compacted to eliminate entrapped air pockets, and moist cured at room temperature and at 100% humidity to solidify. The solidified solidifiable cementitious composition specimens were tested at 7 and 91 days for compressive strength using a standard universal testing machine, as directed by ASTM C109/C109M-99. Compressive strength indicated in Table III below was computed as the average compressive strength for three identical specimens.

The results were as follows, with the percentage after each strength value listed in Table III being the strength of the composition relative to the control composition:

TABLE III

| | Flow Table Results | | |
|---|---|---|---|
| | (% increase over | 7 day | 91 day |
| | undisturbed | Compressive | Compressive |
| | mortar diameter) | Strength (MPa) | Strength (MPa) |
| Control | 21% | 34.7 (100%) | 45.9 (100%) |
| Composition | | | |
| Composition 1 | 45% | 27.2 (78%) | 48.2 (105%) |
| Composition 2 | 33% | 34.7 (100%) | 53.8 (117%) |
| Composition 3 | 29% | 37.0 (107%) | 53.8 (117%) |

As can be seen from Table III, a 20 wt % replacement of Portland cement type I with a blend of calcined kaolin and waste glass powder as in the formulation of composition 2 yielded the highest 91-day long-term strength with a 17% increase over control. Increasing the calcined kaolin content in composition 3 did not produce any additional increase in the long-term strength, but did cause an increase in early (7-day) strength. This increase in both the short-term and the long-term strength of a cementitious composition resulting from the replacement of a portion of the Portland cement in the cementitious composition with a mixture of calcined kaolin and glass powder would not have been expected or predicted by those of skill in the art.

As can also be seen in Composition 1, the replacement of 20 wt % of the Portland cement (Type I) with waste glass powder alone produces only a 5% increase over the control in the 91 day strength and significantly reduces the early strength, by 22%, as expected. As mentioned earlier, this noticeably low early strength performance of compositions comprising glass powder as a pozzolan works to limit the use of such cementitious compositions in general construction practices.

From the flow table results of composition 1, it can also be seen that replacing some of the type I Portland cement with waste glass powder alone produced a significant increase in slump compared with the control composition. From the test results of compositions 2 and 3 it can be seen that adding calcined kaolin to a mixture of Portland Cement Type I and glass powder results in a composition with less slump (less workability) than Composition 1, but the slump (and workability) of Compositions 2 and 3 still represents an improvement over the slump test results of the control composition. This improved workability is highly desirable for improved placement, as discussed above.

These data demonstrate that solidifiable cementitious compositions (e.g., mortars and concretes) formed from cementitious compositions comprising cement, glass powder and calcined kaolin have a workability, as well as long-term strength and early strength performance that is comparable or superior to mortar and concrete products that are made from conventional cementitious compositions. Additionally, solidifiable cementitious compositions formed from cementitious compositions prepared according to the present invention have substantially improved long-term and early strength performance compared to mortar and concrete products that are made from cementitious compositions that contain cement and glass powder, but no calcined kaolin. Such results would be unexpected by one of ordinary skill in the art.

### EXAMPLE II

Several different mortar compositions were formulated in a fashion identical to that described above in Example I, but using a Portland Cement from a different manufacturer. Thus a control solidifiable cementitious composition (in the form of a mortar) was prepared, in which the cementitious material was 100% Portland cement type I. Successive solidifiable cementitious compositions were then prepared in which 20 wt % of the Portland cement type I was replaced with glass powder or a mixture of both glass powder and calcined kaolin, as listed in Table IV below. The glass powder was made from post-consumer mixed waste glass as in Example I. Each of the compositions was placed in a mortar cube shape, and the seven-day compressive strength was tested in the manner described above in Example I. The results are set forth in Table IV, with the percentage after each strength value listed in Table IV being the strength of the composition relative to the control composition:

TABLE IV

| | 7 Day Compressive Strength |
|---|---|
| | (MPa) |
| Control | 38.6 (100%) |
| 20% Glass Powder | 30.1 (78%) |
| 14% Glass Powder + 6% Calcined | 38.7 (100%) |
| Kaolin | |
| 12% Glass Powder + 8% Calcined | 43.6 (113%) |
| Kaolin | |

As can be see from the results in Table IV and consistent with the results of Example I, using waste glass powder alone resulted in a decrease in the early strength of the resulting solidified solidifable cementitious composition, while using a combination of glass powder and calcined kaolin produced a stronger solidified solidifiable cementitious composition. Further increases in the amount of calcined kaolin in the mixture led to further increases in the early strength performance. Consistent with the results of Example I, solidifiable cementitious compositions made from cementitious compositions comprising cement, glass powder and calcined kaolin (i.e., prepared according to the present invention) have substantially improved long-term and early strength performance compared to mortar and concrete products made from cementitious compositions that contain cement and glass powder, but no calcined kaolin.

The consistency of the test results of Example II with the results of Example I also demonstrate that the improved strength performance obtained by the cementitious compositions of the present invention are not specific to the use of Portland Cement from any single manufacturer.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A cementitious composition comprising a cement, glass powder, and calcined kaolin.

2. The cementitious composition according to claim 1, wherein the glass powder is selected from the group consisting of soda-lime glass, borosilicate glass, and lead glass.

3. The cementitious composition according to claim 1, wherein the glass powder comprises particles and substantially all of the particles pass through a No. 70 mesh sieve (U.S.).

4. The cementitious composition according to claim 1, wherein the glass powder comprises particles and wherein about 80% to about 100% of the particles, by weight, pass through a No. 100 mesh sieve (U.S.).

5. The cementitious composition according to claim 1, wherein the cement is selected from the group consisting of Portland cement, high alumina cement, and gypsum.

6. The cementitious composition according to claim 1, comprising about 60% to about 93% of the cement, about 5% to about 38% of the glass powder, and about 2% to about 12% of calcined kaolin.

7. The cementitious composition according to claim 1, wherein the calcined kaolin comprises particles having a particle size of about 0.1 μm to about 50 μm

8. The cementitious composition according to claim 1, wherein the glass powder comprises ground or pulverized post-consumer mixed waste glass.

9. A cementitious binder comprising water and the cementitious composition according to claim 1.

10. The cementitious binder composition according to claim 9, wherein the water and the cementitious composition are present in a weight ratio of about 0.15:1 to about 0.8:1:.

11. The cementitious binder composition according to claim 9, wherein the water and the cementitious composition are present in a weight ratio of about 0.3:1 to about 0.5:1.

12. A solidifiable cementitious composition comprising the cementitious binder composition according to claim 9 and an aggregate.

13. The solidifiable cementitious composition according to claim 12 which is in the form of a mortar.

14. The solidifiable cementitious composition according to claim 12 which is in the form of a concrete.

15. A solidified and cured solidifiable cementitious composition according to claim 12, wherein after curing the soldified solidifiable cementitious composition has a compressive strength of at least about 53 MPa.
